(19) United States
(12) Patent Application Publication
(10) Pub. No.: US 2026/0165402 A1
(43) Pub. Date: Jun. 18, 2026

(54) POLYACRYLONITRILE-BASED ARTIFICIAL HAIR, HEAD ORNAMENT PRODUCT INCLUDING THE SAME, AND METHOD FOR PRODUCING SAME

(71) Applicant: KANEKA CORPORATION, Osaka (JP)

(72) Inventors: Naoto Yoshida, Hyogo (JP); Takaaki Kobashi, Hyogo (JP); Takeshi Tanaka, Hyogo (JP)

(73) Assignee: KANEKA CORPORATION, Osaka (JP)

(21) Appl. No.: 19/535,325

(22) Filed: Feb. 10, 2026

Related U.S. Application Data
(63) Continuation of application No. PCT/JP2024/027946, filed on Aug. 5, 2024.

(30) Foreign Application Priority Data
Aug. 14, 2023 (JP) 2023-132038

(51) Int. Cl. A41G 3/00; A41G 5/00; C08F 214/06; D01D 5/06; D01D 5/253; D01F 6/32; D01F 6/40

(52) U.S. Cl. CPC A41G 3/0083; A41G 5/004; C08F 214/06; D01D 5/06; D01D 5/253; D01F 6/32; D01F 6/40; C08F 2800/20; D10B 2321/101; D10B 2503/08

(57) ABSTRACT

A polyacrylonitrile-based artificial hair has a broad bean-shaped transverse cross section having an outer peripheral shape that includes an upper peripheral portion with a recessed portion having a curved shape at the center, and a lower peripheral portion curved in an arc. In the broad bean-shaped transverse cross section, a ratio of a longest diameter Lf to a shortest diameter Sf is 1.20 or more, and a ratio of a smallest cross-sectional thickness a of the recessed portion to a largest cross-sectional thickness b of protrusions on both sides of the recessed portion is 0.51 to 0.91. A major axis of the broad bean-shaped transverse cross section is located above a bottom of the recessed portion. The major axis is a longest line segment among line segments connecting any two points on an outer periphery of the broad bean-shaped transverse cross section.

### TECHNICAL FIELD

One or more embodiments of the present invention relate to a polyacrylonitrile-based artificial hair to be used in a hair ornament product such as a hairpiece, a hair ornament product including the same, and a method for producing the same.

### BACKGROUND

Conventionally, human hair and artificial hair are used for hair ornament products such as a hairpiece, but it is becoming difficult to obtain human hair, and thus there is an increasing demand for artificial hair. Synthetic fibers produced using a polymer containing acrylonitrile and vinyl chloride have an excellent touch, and have thus been favorably used for artificial hair. For example, Patent Document 1 discloses fibers for hair made of a copolymer containing vinyl chloride, acrylonitrile, and a vinyl monomer copolymerizable therewith.

### Patent Document

Patent Document 1: JP H2-53910A

In recent years, hair ornament products having a gloss appealing to the eyes of consumers tend to be preferred for the purpose of decorativeness, and the fibers for hair disclosed in Patent Document 1 are required to have an improved gloss.

In general, fibers for artificial hair are opened using a hackling apparatus, and it is desired to reduce the number of voids inside the fibers in order to perform the hackling more easily.

One or more embodiments of the present invention provide a polyacrylonitrile-based artificial hair having high process stability, a radiant gloss in which light reflection becomes locally stronger or weaker depending on the viewing angle, and a low void ratio, a hair ornament product including the same, and a method for producing the same.

### SUMMARY

One or more embodiments of the present invention relate to a polyacrylonitrile-based artificial hair having a broad bean-shaped transverse cross section having an outer peripheral shape that includes an upper peripheral portion with a recessed portion having a curved shape at the center, and a lower peripheral portion curved in an arc, wherein in the transverse cross section, a ratio Lf/Sf of a longest diameter Lf to a shortest diameter Sf is 1.20 or more, in the transverse cross section, a ratio a/b of a smallest cross-sectional thickness a of the recessed portion to a largest cross-sectional thickness b of protrusions on both sides of the recessed portion is 0.51 to 0.91, a major axis of the transverse cross section is located above a bottom of the recessed portion, the major axis is a longest line segment among line segments connecting any two points on an outer periphery of the transverse cross section, the longest diameter Lf indicates a length of the major axis and the shortest diameter Sf indicates a direct distance between two parallel lines that are parallel to the major axis and between which the transverse cross section is sandwiched, and the smallest cross-sectional thickness a of the recessed portion indicates the smallest thickness of a portion right below the bottom of the recessed portion in the transverse cross section and the largest cross-sectional thickness b of the protrusions indicates the largest thickness of portions above the bottom of the recessed portion in the protrusions in the transverse cross section.

One or more embodiments of the present invention relate to a hair ornament product including the polyacrylonitrile-based artificial hair.

One or more embodiments of the present invention relate to a method for producing a polyacrylonitrile-based artificial hair, including performing wet spinning using a spinning solution containing an acrylonitrile copolymer, wherein a nozzle used for the wet spinning has a broad bean-shaped transverse cross section having an outer peripheral shape that includes an upper peripheral portion with a recessed portion having a curved shape at the center, and a lower peripheral portion curved in an arc, a ratio Ln/Sn of a longest diameter Ln of the transverse cross section of the nozzle to a shortest diameter Sn thereof is 1.60 or more, in the transverse cross section of the nozzle, a ratio Sr/Sn of a depth Sr of the recessed portion to the shortest diameter Sn is 0.40 to 0.65, a major axis of the transverse cross section of the nozzle is located above a bottom of the recessed portion, the major axis is a longest line segment among line segments connecting any two points on an outer periphery of the transverse cross section of the nozzle, the longest diameter Ln indicates a length of the major axis and the shortest diameter Sn indicates a direct distance between two parallel lines that are parallel to the major axis and between which the transverse cross section of the nozzle is sandwiched, and the depth Sr of the recessed portion indicates a direct distance from the bottom of the recessed portion to a parallel line that is one of the two parallel lines and is located above the bottom of the recessed portion.

With one or more embodiments of the present invention, it is possible to provide a polyacrylonitrile-based artificial hair having high process stability, a radiant gloss in which light reflection becomes locally stronger or weaker depending on the viewing angle, and a low void ratio, and a hair ornament product including the same.

Also, with the production method of one or more embodiments of the present invention, it is possible to obtain, through a wet spinning, a polyacrylonitrile-based artificial hair having a radiant gloss in which light reflection becomes locally stronger or weaker depending on the viewing angle, and a low void ratio, with high productivity.

### BRIEF DESCRIPTION OF THE DRAWINGS

FIG. 1 is a schematic transverse cross-sectional view of a polyacrylonitrile-based artificial hair according to an example of one or more embodiments of the present invention.

FIG. 2 is a schematic transverse cross-sectional view of a polyacrylonitrile-based artificial hair according to another example of one or more embodiments of the present invention.

FIG. 3 is a schematic transverse cross-sectional view of a polyacrylonitrile-based artificial hair according to yet another example of one or more embodiments of the present invention.

FIG. 4 is a schematic transverse cross-sectional view of a wet-spinning nozzle according to an example used in examples.

FIG. 5 is a schematic transverse cross-sectional view of a wet-spinning nozzle used in Comparative Example 2.

FIG. 6 is a schematic transverse cross-sectional view of a wet-spinning nozzle used in Comparative Example 3.

FIG. 7 is a schematic transverse cross-sectional view of a wet-spinning nozzle used in Comparative Example 4.

FIG. 8 is a photograph (400-fold magnification) showing the transverse cross section of the polyacrylonitrile-based artificial hair of Working Example 1.

FIG. 9 is a photograph (400-fold magnification) showing the transverse cross section of the polyacrylonitrile-based artificial hair of Comparative Example 1.

FIG. 10 is a photograph (400-fold magnification) showing the transverse cross section of the polyacrylonitrile-based artificial hair of Comparative Example 2.

FIG. 11 is a photograph (400-fold magnification) showing the transverse cross section of the polyacrylonitrile-based artificial hair of Comparative Example 3.

FIG. 12 is a photograph (400-fold magnification) showing the transverse cross section of the polyacrylonitrile-based artificial hair of Comparative Example 4.

### DETAILED DESCRIPTION

The inventors of one or more embodiments of the present invention found that setting the transverse cross-sectional shape of a polyacrylonitrile-based artificial hair to a broad bean shape as well as setting the position of the major axis in the transverse cross section, the ratio Lf/Sf of the longest diameter Lf to the shortest diameter Sf, and the ratio a/b of the smallest cross-sectional thickness a of the recessed portion to the largest cross-sectional thickness b of the protrusion to be within respective predetermined ranges makes it possible to allow the polyacrylonitrile-based artificial hair to have high process stability, a radiant gloss (also referred to merely as “radiant gloss” hereinafter) in which light reflection becomes locally stronger or weaker depending on the viewing angle, and a reduced void ratio.

Also, they found that using a nozzle (also referred to as a “spinning nozzle”) that has a substantially broad bean-shaped transverse cross section and in which the position of the major axis, the ratio Ln/Sn of the longest diameter Ln of the transverse cross section to the shortest diameter Sn thereof, and the ratio Sr/Sn of the depth Sr of the recessed portion to the shortest diameter Sn are set to be within respective predetermined ranges makes it possible to obtain, through wet spinning, the polyacrylonitrile-based artificial hair having a radiant gloss and a reduced void ratio, with high productivity.

In this specification, when a numerical range is shown using “to”, the numerical range includes the values at both ends (i.e., the upper limit and the lower limit). For example, a numerical range “X to Y” is a range that includes X and Y, which are the values at the two ends of the range, and is the same range as “X or more and Y or less”. Also, any number and any included range falling within the range is specifically disclosed. Also, when a plurality of numerical ranges are described in this specification, numerical ranges obtained by using the upper limits and the lower limits of the different numerical ranges in combination as appropriate are included.

### Polyacrylonitrile-Based Artificial Hair

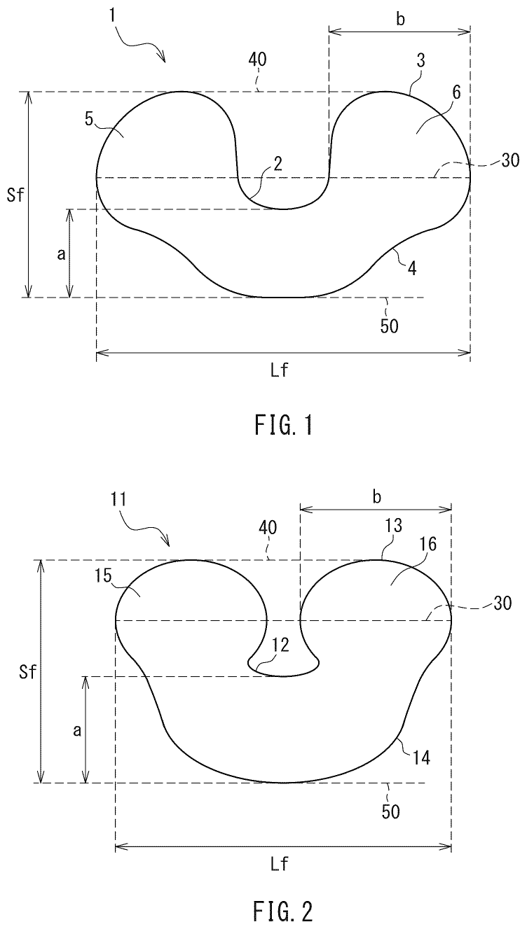

In one or more embodiments of the present invention, the polyacrylonitrile-based artificial hair has a broad bean-shaped transverse cross section. In this specification, the broad bean shape has an outer peripheral shape that includes an upper peripheral portion with a recessed portion having a curved shape at the center, and a lower peripheral portion curved in an arc, and encompasses a substantially broad bean-shape in which a portion of the outer peripheral shape is a linear shape. In the transverse cross section, the bottom of the recessed portion is used as a reference, and a portion above the bottom of the recessed portion is an upper side or upper portion, while a portion below the bottom of the recessed portion is a lower side or lower portion. FIGS. 1 to 3 show schematic transverse cross-sectional views of the polyacrylonitrile-based artificial hair according to one or more embodiments of the present invention as examples, but there is no limitation thereto.

FIG. 1 is a schematic transverse cross-sectional view of the polyacrylonitrile-based artificial hair according to an example.

In this embodiment, polyacrylonitrile-based artificial hair 1 has a substantially broad bean-shaped cross section having an outer peripheral shape that includes an upper peripheral portion 3 with a recessed portion 2 having a curved shape approximately at the center, and a lower peripheral portion 4 curved in an arc. A protrusion 5 and a protrusion 6 are formed on both sides of the recessed portion 2. The recessed portion 2 gradually increases in width upward from the bottom, and it can also be said that the recessed portion 2 has a substantially inverted trapezoidal shape.

FIG. 2 is a schematic transverse cross-sectional view of the polyacrylonitrile-based artificial hair according to another example.

In this embodiment, polyacrylonitrile-based artificial hair 11 has a substantially broad bean-shaped cross section having an outer peripheral shape that includes an upper peripheral portion 13 with a curved recessed portion 12 approximately at the center, and a lower peripheral portion 14 curved in an arc. A protrusion 15 and a protrusion 16 are formed on both sides of the recessed portion 12. The recessed portion 12 has a substantially constricted shape.

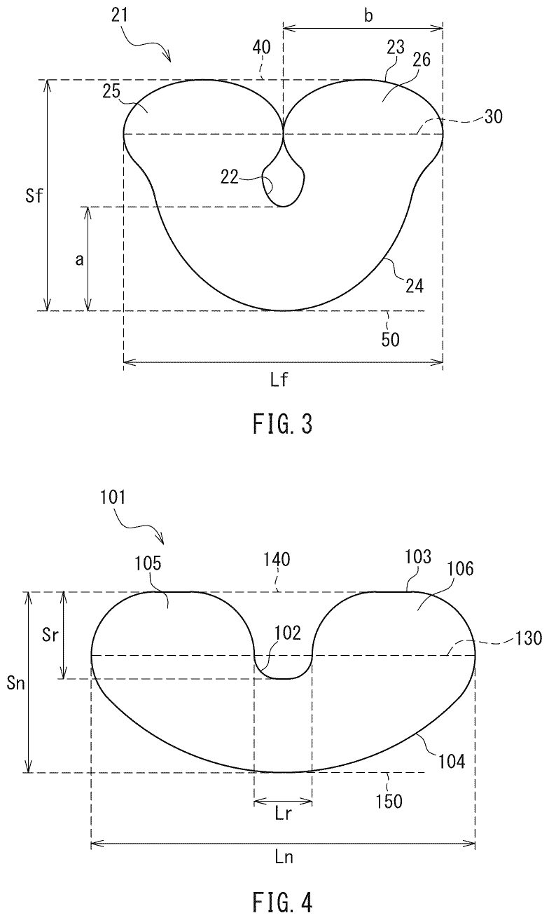

FIG. 3 is a schematic transverse cross-sectional view of the polyacrylonitrile-based artificial hair (also referred to merely as “artificial hair” hereinafter) according to yet another example.

In this embodiment, polyacrylonitrile-based artificial hair 21 has a substantially broad bean-shaped cross section having an outer peripheral shape that includes an upper peripheral portion 23 with a curved recessed portion 22 approximately at the center, and a lower peripheral portion 24 curved in an arc. A protrusion 25 and a protrusion 26 are formed on both sides of the recessed portion 22. The recessed portion 22 has a substantially constricted shape divided due to contact between a portion of an side portion of the protrusion 25 close to the center and a portion of an side portion of the protrusion 26 close to the center.

In the transverse cross section of the artificial hair, the ratio Lf/Sf (also referred to as the “aspect ratio” hereinafter) of the longest diameter Lf to the shortest diameter Sf is 1.20 or more. This makes it likely that the polyacrylonitrile-based artificial hair has a radiant gloss in which light reflection becomes locally stronger or weaker depending on the viewing angle. The aspect ratio of the transverse cross section of the artificial hair may be 1.25 or more, 1.30 or more, or 1.40 or more. The upper limit of the aspect ratio of the transverse cross section of the artificial hair is not particularly limited, and may be 2.00 or less from the viewpoint that, for example, the artificial hair is likely to have a deep hue. In this specification, the longest diameter Lf and the shortest diameter Sf of the transverse cross section of the polyacrylonitrile-based artificial hair can be measured as described in Examples.

The longest diameter Lf of the transverse cross section of the artificial hair indicates the length of the major axis, which is the longest line segment among line segments connecting any two points on the outer periphery of the transverse cross section, and the shortest diameter Sf of the transverse cross section of the artificial hair indicates a direct distance between two parallel lines that are parallel to the major axis and between which the transverse cross section is sandwiched. For example, in FIGS. 1 to 3, the longest diameter Lf of the transverse cross section of the artificial hair is the length of a major axis 30, which is the longest line segment among line segments connecting any two points on the outer periphery of the transverse cross section, and the shortest diameter Sf of the transverse cross section is a direct distance between two parallel lines 40 and 50 that are parallel to the major axis 30 and between which the transverse cross section is sandwiched.

The longest diameter Lf of the transverse cross section of the artificial hair is not particularly limited, and may be 80.0 μm or more, 80.5 μm or more, or 81.0 μm or more, from the viewpoint that, for example, the artificial hair is more likely to have a radiant gloss. The longest diameter Lf of the transverse cross section of the artificial hair may be 90.5 μm or less from the viewpoint that the void ratio is likely to be reduced.

The shortest diameter Sf of the transverse cross section of the artificial hair is not particularly limited, and may be 40 μm or more, 45 μm or more, or 50 μm or more, from the viewpoint that, for example, the artificial hair is more likely to have a radiant gloss. The shortest diameter Sf of the transverse cross section of the artificial hair may be 75 μm or less, 65 μm or less, or 60.0 μm or less, from the viewpoint that the artificial hair is more likely to have a deep hue.

In the transverse cross section of the artificial hair, the ratio a/b (also referred to merely as the “cross-sectional thickness ratio” hereinafter) of the smallest cross-sectional thickness a of the recessed portion to the largest cross-sectional thickness b of the protrusion is 0.51 to 0.91. Thus, the occurrence of voids inside artificial hair is suppressed, resulting in a low void ratio. The cross-sectional thickness ratio of the transverse cross section of the artificial hair may be 0.55 or more, 0.60 or more, 0.65 or more, 0.70 or more, or 0.730 or more.

In this specification, the smallest cross-sectional thickness a of the recessed portion in the transverse cross section of the artificial hair indicates the smallest thickness of a portion right below the bottom of the recessed portion at the center of the upper portion in the transverse cross section, and the largest cross-sectional thickness b of the protrusion in the transverse cross section of the artificial hair indicates the largest thickness of portions above the bottom of the recessed portion in the protrusions on both sides of the recessed portion, in the transverse cross section. For example, in FIGS. 1 to 3, the smallest cross-sectional thickness a of the recessed portion in the transverse cross section of the artificial hair is the smallest thickness of a portion right below the recessed portion 2 (12, 22) at the center of the upper portion in the transverse cross section, and the largest cross-sectional thickness b of the protrusion in the transverse cross section of the artificial hair is the largest thickness of portions above the bottom of the recessed portion 2 (12, 22) in the protrusions 5 and 6 (15, 16; 25, 26) on both sides in the transverse cross section. The largest cross-sectional thickness b of the protrusion in the transverse cross section of the artificial hair can also be indicated by the length of a line segment on the major axis 30 passing through the protrusion. In this specification, the smallest cross-sectional thickness a of the recessed portion and the largest cross-sectional thickness b of the protrusion in the transverse cross section of the polyacrylonitrile-based artificial hair can be measured as described in Examples.

In the transverse cross section of the artificial hair, the major axis is located above the bottom of the recessed portion. This improves the productivity and makes it likely that the cross-sectional thickness ratio is within the range described above.

The smallest cross-sectional thickness a of the recessed portion in the transverse cross section of the artificial hair is not particularly limited, and may be 26.5 μm or more, 27.0 μm or more, or 27.5 μm or more, from the viewpoint of, for example, further reducing the void ratio. The smallest cross-sectional thickness a of the recessed portion in the transverse cross section of the artificial hair is not particularly limited, and may be 40.0 μm or less, 35.0 μm or less, or 33.0 μm or less, from the viewpoint that, for example, high process stability is likely to be maintained.

The largest cross-sectional thickness b of the protrusion in the transverse cross section of the artificial hair is not particularly limited, and may be 30.0 μm or more, 33.0 μm or more, or 36.0 μm or more, from the viewpoint of, for example, the productivity. The largest cross-sectional thickness b of the protrusion in the transverse cross section of the artificial hair is not particularly limited, and may be 42.0 μm or less, 41.0 μm or less, or 40.5 μm or less, from the viewpoint of, for example, further reducing the void ratio.

In the transverse cross section of the artificial hair, the ratio b/Lf (also referred to merely as “b/Lf” hereinafter) of the largest cross-sectional thickness b of the protrusion to the longest diameter Lf is not particularly limited, and may be 0.450 or more from the viewpoint of, for example, further reducing the void ratio. In the transverse cross section of the artificial hair, b/Lf is not particularly limited, and may be 0.7 or less from the viewpoint that, for example, the artificial hair is likely to have a deep hue.

In the transverse cross section of the artificial hair, the ratio a/Sf (also referred to merely as “a/Sf” hereinafter) of the smallest cross-sectional thickness a of the recessed portion to the shortest diameter Sf is not particularly limited, and may be 0.400 or more, 0.450 or more, or 0.470 or more, from the viewpoint of, for example, further reducing the void ratio. In the transverse cross section of the artificial hair, the upper limit of a/Sf is not particularly limited, and may be 0.75 or less from the viewpoint that, for example, high process stability is maintained.

The single fiber fineness of the polyacrylonitrile-based artificial hair may be 20 to 90 dtex, 25 to 80 dtex, 35 to 70 dtex, or 30 to 60 dtex, from the viewpoint of making the polyacrylonitrile-based artificial hair suitable for artificial hair. In this specification, the single fiber fineness means an average value of fineness of random 100 single fibers.

Individual artificial hairs included in the polyacrylonitrile-based artificial hair need not necessarily have the same fineness and the same cross-sectional size, and artificial hairs that are different in fineness and cross-sectional size may be mixed together.

The void ratio of the polyacrylonitrile-based artificial hair may be 30% or less, 25% or less, 15% or less, 10% or less, or 5% or less, from the viewpoint of performing the hackling more easily. In this specification, the void ratio of the polyacrylonitrile-based artificial hair can be measured as described in Examples.

The average reflectance of the polyacrylonitrile-based artificial hair within a wavelength range (visible ray of light) of 440 to 660 nm (at intervals of 10 nm) may be 1.75% or less, 1.70% or less, or 1.68% or less, from the viewpoint that the artificial hair is likely to have a radiant gloss. The average reflectance of the polyacrylonitrile-based artificial hair within a wavelength range of 440 to 660 nm may be 1.20% or more from the viewpoint that the artificial hair is likely to have a radiant gloss.

The acrylonitrile copolymer included in the polyacrylonitrile-based artificial hair is not particularly limited as long as it contains a constitutional unit derived from acrylonitrile in an amount of 25 mass % or more, and, for example, an acrylonitrile copolymer containing a constitutional unit derived from acrylonitrile in an amount of 25 mass % to 100 mass % and a constitutional unit derived from another monomer in an amount of 0 mass % to 75 mass % can be used. The acrylonitrile copolymer may contain a constitutional unit derived from acrylonitrile in an amount of 95 mass % or less and a constitutional unit derived from another monomer in an amount of 5 mass % or more, or a constitutional unit derived from acrylonitrile in an amount of 90 mass % or less and a constitutional unit derived from another monomer in an amount of 10 mass % or more, and may contain a constitutional unit derived from acrylonitrile in an amount of 25 mass % or more and less than 80 mass % and a constitutional unit derived from another monomer in an amount of more than 20 mass % and 75 mass % or less of.

The other monomer is not particularly limited as long as it is copolymerizable with acrylonitrile, and examples thereof include halogen-containing monomers such as vinyl chloride and vinylidene chloride; unsaturated carboxylic acids such as acrylic acid and methacrylic acid and salts thereof, (meth)acrylic acid esters such as methyl (meth)acrylate; unsaturated carboxylic acid esters such as glycidyl methacrylate; vinyl esters such as vinyl acetate and vinyl butyrate; sulfonic acid group-containing vinyl monomers; and the like. One type of these other monomers may be used alone or two or more of them may be used in combination.

Examples of the sulfonic acid group-containing vinyl monomers include allylsulfonic acid, methallylsulfonic acid, styrenesulfonic acid, isoprenesulfonic acid, and 2-acrylamido-2-methylpropanesulfonic acid, and metallic salts (e.g., sodium salts) thereof and amine salts thereof. One of the sulfonic acid group-containing vinyl monomers may be used alone, or two or more of them may be used in combination.

Specifically, the acrylonitrile copolymer may contain a constitutional unit derived from acrylonitrile in an amount of 29.5 mass % to 79.5 mass %, a constitutional unit derived from vinyl chloride and/or vinylidene chloride in an amount of 20 mass % to 70 mass %, and a constitutional unit derived from a sulfonic acid group-containing vinyl monomer in an amount of 0.5 mass % to 5 mass %. When the content of the constitutional unit derived from acrylonitrile in the acrylonitrile copolymer is within the range described above, the polyacrylonitrile-based artificial hair has favorable thermal resistance. In the acrylonitrile copolymer, when the content of the constitutional unit derived from vinyl chloride and/or vinylidene chloride is within the range described above, the polyacrylonitrile-based artificial hair has favorable flame retardancy. When the content of a sulfonic acid group-containing vinyl monomer in the acrylonitrile copolymer is within the range described above, the polyacrylonitrile-based artificial hair has favorable hydrophilicity.

The acrylonitrile copolymer may contain a constitutional unit derived from acrylonitrile in an amount of 34.5 mass % to 74.5 mass %, a constitutional unit derived from vinyl chloride and/or vinylidene chloride in an amount of 25 mass % to 65 mass %, and a constitutional unit derived from a sulfonic acid group-containing vinyl monomer in an amount of 0.5 mass % to 5 mass %. The acrylonitrile copolymer may contain the constitutional unit derived from vinyl chloride from the viewpoint of achieving better touch of the polyacrylonitrile-based artificial hair.

The polyacrylonitrile-based artificial hair may contain an additive to improve the artificial hair characteristics if necessary as long as the effects of one or more embodiments of the present invention are not hindered. Examples of the additive include functional agents such as a coloring agent, a gloss control agent, a stabilizer, a fiber sizing agent, a deodorant, and an aromatic agent. One of these additives may be used alone, or two or more of them may be used in combination. The polyacrylonitrile-based artificial hair may contain the additives in an amount of, for example, 10 parts by mass or less with respect to 100 parts by mass of the acrylonitrile copolymer. In other words, the polyacrylonitrile-based artificial hair is artificial hair containing an acrylonitrile copolymer as a main component, and may contain the acrylonitrile copolymer in an amount of 91 mass % to 100 mass % and the additive in an amount of 9 mass % or less.

The polyacrylonitrile-based artificial hair may contain a coloring agent from the viewpoint of adjusting a hue. The coloring agent may be a pigment or a dye. The pigment may be an inorganic pigment or an organic pigment. Two or more types of pigments may be used together, or a pigment and a dye may be used together. The pigment may be carbon black because it can be used to color the polyacrylonitrile-based artificial hair black with a desirable hue and is readily available.

The polyacrylonitrile-based artificial hair may contain a coloring agent in an amount of 0.01 to 2.00 parts by mass, or 0.02 to 0.60 parts by mass, with respect to 100 parts by mass of the acrylonitrile copolymer from the viewpoint of coloring the polyacrylonitrile-based artificial hair to a desired hues and suppressing yarn breakage during combing.

An oil (also referred to as a “fiber treatment agent”) may be attached to the polyacrylonitrile-based artificial hair. The oil is not particularly limited, and those used for the purpose of preventing static electricity during the production of the polyacrylonitrile-based artificial hair, preventing agglutination of the artificial hair, and improving the texture can be used as appropriate. A known oil can be used as the oil, and examples thereof include anionic surfactants such as phosphoric acid ester salts and sulfuric acid ester salts; cationic surfactants such as quaternary ammonium salts and imidazolium salts; nonionic surfactants such as ethylene oxide adducts and/or propylene oxide adducts of oils or fats, and polyhydric alcohol partial esters; fats and oils from animals and plants, mineral oils, fatty acid esters; silicone-based surfactants such as amino-modified silicone; and the like. One of these oils may be used alone, or two or more of them may be used in combination.

The adhesion amount of the oil is not particularly limited, and may be 0.06 to 1.0 part by mass, 0.1 to 0.6 parts by mass, or 0.15 to 0.35 parts by mass with respect to 100 parts by mass of the polyacrylonitrile-based artificial hair, from the viewpoint of preventing static electricity, preventing agglutination of the artificial hair, and improving the texture. In this specification, the adhesion amount of the oil in the polyacrylonitrile-based artificial hair can be measured and calculated as described in Examples.

### Method for Producing Polyacrylonitrile-Based Artificial Hair

The polyacrylonitrile-based artificial hair can be produced through wet spinning using a spinning solution containing the acrylonitrile copolymer described above. The wet spinning includes at least a step (also referred to as a “coagulation step” hereinafter) of coagulating a spinning solution extruded into a coagulation bath, and a step (also referred to as a “drawing step” hereinafter) of drawing, in a drawing bath, filaments obtained in the coagulation step.

The spinning solution contains, for example, the acrylonitrile copolymer and an organic solvent. The spinning solution may be a liquid in which the acrylonitrile copolymer and the organic solvent are mixed in a spinnable state. The acrylonitrile copolymer need not be completely dissolved in the organic solvent as long as spinning can be performed, but it is preferable that in the spinning solution, the acrylonitrile copolymer is completely dissolved in the organic solvent.

As the acrylonitrile copolymer, the acrylonitrile copolymers described above can be used as appropriate. The specific viscosity of the acrylonitrile copolymer may be 0.1 to 0.3, or 0.15 to 0.25 from the viewpoint of solubility in the organic solvent. In this specification, a polymer solution is prepared by dissolving 2 g of the acrylonitrile copolymer in 1 L of dimethylformamide, and the specific viscosity of the prepared polymer solution measured using an Ostwald viscometer at 30° C. is defined as the specific viscosity of the acrylonitrile copolymer.

The organic solvent is not particularly limited, and a good solvent for the acrylonitrile copolymer can be used as appropriate. Examples of the organic solvent include acetone, dimethyl sulfoxide, N,N-dimethylformamide, N,N-dimethylacetamide, and the like. Out of these organic solvents, dimethyl sulfoxide is preferable from the viewpoint of productivity and safety.

The spinning solution may contain a coloring agent. As the coloring agent, a solid powdery pigment may be used, or a pigment dispersion liquid containing the pigment dispersed in a dispersion medium may be used. It is preferable to prepare a spinning solution using the pigment dispersion liquid from the viewpoint of dispersibility of the pigment in the spinning solution and the polyacrylonitrile-based artificial hair. As the pigment, the pigments described above can be used as appropriate.

The spinning solution may contain an epoxy group-containing compound in an amount of 0.1 parts by mass or more, 0.2 parts by mass or more, or 0.3 parts by mass or more, with respect to 100 parts by mass of the acrylonitrile copolymer. It is preferable that the spinning solution contains the epoxy group-containing compound because foul odor, coloring of the artificial hair caused by heat, devitrification of the artificial hair caused by hot water, and the like can be suppressed. In particular, when dimethyl sulfoxide is used as the organic solvent, the epoxy group-containing compound can effectively suppress the generation of malodorous components caused by the decomposition of the dimethyl sulfoxide while the polyacrylonitrile-based artificial hair is being heated. Also, the spinning solution may contain the epoxy group-containing compound in an amount of 5 parts by mass or less, 3 parts by mass or less, or 1 part by mass or less, with respect to 100 parts by mass of the acrylonitrile copolymer from the viewpoint of spinnability, the quality of the artificial hair, and cost.

Examples of the epoxy group-containing compound include a glycidyl (meth)acrylate-containing polymer, an epoxidized vegetable oil, a glycidyl ether epoxy resin, a glycidyl amine epoxy resin, a glycidyl ester epoxy resin, a cyclic aliphatic epoxy resin, and the like. One of these epoxy group-containing compounds may be used alone, or two or more of them may be used in combination.

The epoxy group-containing compound may be the glycidyl (meth)acrylate-containing polymer, or polyglycidyl methacrylate, from the viewpoint of epoxy equivalent (i.e., the weight of the resin containing 1 equivalent of epoxy group), suppressing the coloring of the artificial hair, the solubility in dimethyl sulfoxide, and reducing the elution into a spinning bath.

The weight average molecular weight of the epoxy group-containing compound is not particularly limited, and may be determined as appropriate in view of, for example, the solubility in dimethyl sulfoxide and the elution into a spinning bath. When the epoxy group-containing compound is a glycidyl (meth)acrylate-containing polymer, the weight average molecular weight may be, for example, 3000 or more from the viewpoint of reducing the elution into the spinning bath or 100000 or less from the viewpoint of the solubility in an organic solvent such as dimethyl sulfoxide.

The spinning solution may contain water, and may contain water in an amount of, for example, 8 to 16 parts by mass or 8 to 15 parts by mass with respect to 100 parts by mass of the acrylonitrile copolymer. The spinning solution may contain other additives to improve the characteristics of the artificial hair if necessary as long as the effects of one or more embodiments of the present invention are not hindered. As the additives above, those for use in the polyacrylonitrile-based artificial hair described above can be used as appropriate.

The concentration of a solid content in the spinning solution is not particularly limited, and may be, for example, 22 mass % to 28 mass %. Thus, filaments obtained in the coagulation step have favorable extensibility, and polyacrylonitrile artificial hair that has suitable gloss for artificial hair and in which occurrence of yarn breakage during combing is suppressed is likely to be obtained. In the spinning solution, the solid content includes the acrylonitrile copolymer and solid additives such as the pigment and the dye.

A method for producing the spinning solution is not particularly limited as long as various components contained in the spinning solution can be uniformly mixed. When the spinning solution contains a pigment, the pigment dispersion liquid may be used. As the pigment dispersion liquid, a dispersion liquid obtained by dispersing the pigment in an organic solvent can be used. The organic solvent is not particularly limited, and the good solvent for the acrylonitrile copolymer described above may be used.

Specifically, the spinning solution may be produced by mixing the pigment dispersion liquid with the acrylonitrile copolymer and/or a polymer solution obtained by dissolving the acrylonitrile copolymer in the organic solvent. A mixed solution obtained by mixing the pigment dispersion liquid with the acrylonitrile copolymer and/or the polymer solution obtained by dissolving the acrylonitrile copolymer in the organic solvent can be used as the spinning solution without being processed or after the concentration adjustment performed to set the concentration of the solid content to 22 mass % to 28 mass %. The method for adjusting the concentration is not particularly limited, and examples thereof include a method in which the organic solvent is added to the mixed solution above, a method in which solid components such as the acrylonitrile copolymer and the pigment are added to the mixed solution above, and a method in which the mixed solution is concentrated by distilling the organic solvent and the like out of the mixed solution above.

Examples of the method for preparing the spinning solution may include a method in which a spinning solution is prepared by mixing the raw materials of the spinning solution such that the concentration of the solid content is 28 mass % or less, and a method in which a mixed solution obtained by mixing the raw materials of the spinning solution such that the concentration of the solid content is more than 28 mass % is diluted with the organic solvent.

When the spinning solution is prepared, it is preferable to add the organic solvent to one or more types of solutions selected by the pigment dispersion liquid, the polymer solution, and a colored polymer solution containing the acrylonitrile copolymer, the pigment, and the organic solvent.

In the coagulation step, the spinning solution is discharged through the spinning nozzle into a coagulation bath and is then coagulated to form filaments. It is preferable to use a mixed solution of water and an organic solvent as the coagulation bath from the viewpoint of ease of controlling the coagulation state. Specifically, an aqueous solution of an organic solvent containing the organic solvent in an amount of 20 mass % to 75 mass % and water in an amount of 25 mass % to 80 mass % may be used as the coagulation bath. The temperature of the coagulation bath may be, for example, from 5° C. to 50° C.

The organic solvent used in the coagulation bath is not particularly limited as long as it is a good solvent for the acrylonitrile copolymer. It is preferable to use one or more selected from the group consisting of dimethyl sulfoxide, N,N-dimethylformamide, N,N-dimethylacetamide, dimethyl sulfone, ¿-caprolactam, ethylene carbonate, and sulfolane from the viewpoint of the productivity of the polyacrylonitrile-based artificial hair, and it is more preferable to use dimethyl sulfoxide from the viewpoint of safety. It is preferable that the organic solvent in the spinning solution and the organic solvent in the coagulation bath are the same from the viewpoint of the quality of the polyacrylonitrile-based artificial hair and ease of process control.

The temperature of the spinning solution extruded into the coagulation bath is not particularly limited, and may be 20° C. to 80° C. from the viewpoint that, for example, the spinning solution can be stably kept in a stock solution tank without being changed over time.

For example, a nozzle with a broad bean-shaped transverse cross section can be used as the nozzle used for the wet spinning. In the transverse cross section of the nozzle, the broad bean shape has an outer peripheral shape that includes an upper peripheral portion with a recessed portion having a curved shape at the center, and a lower peripheral portion curved in an arc, and encompasses a substantially broad bean-shape in which a portion of the outer peripheral shape is a linear shape. In the transverse cross section of the nozzle, the bottom of the recessed portion is used as a reference, and a portion above the bottom of the recessed portion is an upper side or upper portion, while a portion below the bottom of the recessed portion is a lower side or lower portion.

FIG. 4 is a schematic transverse cross-sectional view of a wet-spinning nozzle according to an example. In this example, a nozzle 101 has a substantially broad bean-shaped transverse cross section having an outer peripheral shape that includes an upper peripheral portion 103 with a recessed portion 102 having a curved shape approximately at the center, and a lower peripheral portion 104 curved in an arc. A protrusion 105 and a protrusion 106 are formed on both sides of the recessed portion 102. The recessed portion 102 gradually increases in width upward from the bottom, and it can also be said that the recessed portion 102 has a substantially inverted trapezoidal shape.

In the transverse cross section of the nozzle, the ratio Ln/Sn (also referred to as the “aspect ratio” hereinafter) of the longest diameter Ln to the shortest diameter Sn is 1.60 or more. This makes it likely to obtain polyacrylonitrile-based artificial hair with a radiant gloss having an aspect ratio of 1.20 or more through wet spinning. The aspect ratio of the transverse cross section of the nozzle may be 1.70 or more, 1.80 or more, or 1.90 or more. The upper limit of the aspect ratio of the transverse cross section of the nozzle is not particularly limited, and may be 2.10 or less from the viewpoint that, for example, polyacrylonitrile-based artificial hair with a deep hue is likely to be obtained.

The longest diameter Ln of the transverse cross section of the nozzle indicates the length of the major axis, which is the longest line segment among line segments connecting any two points on the outer periphery of the transverse cross section of the nozzle, and the shortest diameter Sn of the transverse cross section of the nozzle indicates a direct distance between two parallel lines that are parallel to the major axis and between which the transverse cross section of the nozzle is sandwiched. For example, in FIG. 4, the longest diameter Ln of the transverse cross section of the nozzle is the length of a major axis 130, which is the longest line segment among line segments connecting any two points on the outer periphery of the transverse cross section, and the shortest diameter Sn of the transverse cross section of the nozzle is a direct distance between two parallel lines 140 and 150 that are parallel to the major axis 130 and between which the transverse cross section of the nozzle is sandwiched.

In the transverse cross section of the nozzle, the ratio Sr/Sn (also referred to as the “depth ratio” hereinafter) of the depth Sr of the recessed portion to the shortest diameter Sn may be 0.40 to 0.65. In this specification, the depth Sr of the recessed portion means a direct distance from a parallel line that is one of two parallel lines that are parallel to the major axis and between which the transverse cross section of the nozzle is sandwiched, the one parallel line being located above the bottom of the recess, to the bottom of the recessed portion. This allows high process stability to be achieved in wet spinning, thus making it likely to obtain polyacrylonitrile-based artificial hair with a radiant gloss and a low void ratio. The depth ratio of the transverse cross section of the nozzle may be 0.42 to 0.60, 0.44 to 0.58, or 0.45 to 0.57. For example, in FIG. 4, the depth Sr of the recessed portion is expressed as the direct distance from a parallel line 140 located above the bottom of the recessed portion to the bottom of the recessed portion.

In the transverse cross section of the nozzle, the major axis is located above the bottom of the recessed portion. This achieves high process stability in wet spinning, thus making it possible to obtain polyacrylonitrile-based artificial hair with a radiant gloss and a low void ratio with high productivity.

In the transverse cross section of the nozzle, the ratio Lr/Ln (also referred to as the “width ratio” hereinafter) of the width Lr of the recessed portion to the longest diameter Ln may be 0.125 or more, 0.130 or more, or 0.135 or more, from the viewpoint that the void ratio of the polyacrylonitrile-based artificial hair is likely to be further reduced. The width ratio of the transverse cross section of the nozzle may be 0.16 or less from the viewpoint that polyacrylonitrile-based artificial hair having a radiant gloss is likely to be obtained. In this specification, the width of the recessed portion in the transverse cross section of the nozzle means the width of the recessed portion on the major axis. For example, in FIG. 4, the width of the recessed portion is indicated as Lr.

The spinning rate is not particularly limited, and may be 2 m/min to 17 m/min from the viewpoint of, for example, industrial productivity.

The filaments produced by coagulating the spinning solution in the coagulation bath are subsequently drawn in the drawing bath. A method for transferring the filaments from the coagulation bath to the drawing bath is not particularly limited. Typically, the filaments are hung between a roll in the coagulation bath and one or more rolls for fiber transfer outside the coagulation bath, and the filaments are transferred to the drawing bath by rotating the rolls.

The drawing bath is not particularly limited as long as drawing can be favorably performed. For example, water or an aqueous solution of an organic solvent containing the organic solvent at a lower concentration than in the coagulation bath can be used as the drawing bath. For example, it is preferable to use an aqueous solution of an organic solvent containing the organic solvent in an amount of 10 mass % to 90 mass % and water in an amount of 10 mass % to 90 mass % as the drawing bath. Note that when the drawing is performed using a water bath, the drawing step may be performed after the water-washing step, which will be described later, or the drawing and the water washing may be performed simultaneously.

The filaments transferred to the drawing bath are hung between an upstream drawing roll on the upstream side in the fiber transfer direction and a downstream drawing roll on the downstream side in the fiber transfer direction in the drawing bath, and are then drawn due to the rotation of the upstream drawing roll (which may be referred to as a “first drawing roll”) and the downstream drawing roll (which may be referred to as a “second drawing roll”).

In the drawing step, the drawing ratio is expressed as a ratio of the length of drawn filaments to the length of undrawn filaments, and may be more than onefold and eightfold or less from the viewpoint of enhancing the strength and the productivity of the filaments. The drawing ratio is adjusted by adjusting the tension applied to the filaments drawn by the first drawing roll and the second drawing roll, and the rotation speeds of the first drawing roll and the second drawing roll.

The length of the filaments in the drawing bath in the transfer direction means the distance between the first drawing roll and the second drawing roll, and may be referred to as a “distance between the rolls”. The distance between the rolls may be 90 cm or more. A plurality of drawing baths are used in some cases, but in such cases, the length of the filaments in the drawing bath in the transfer direction is the sum of the distances between the rolls in the drawing baths. The drawn filaments are hung on a roll such as a clover roll provided outside the drawing bath and are collected from the drawing bath as appropriate.

The drawing in the drawing bath may be performed in a plurality of stages. It is preferable that the average values of the drawing speeds are different between at least two stages of the plurality of stages of the drawing. When the drawing in the drawing bath is performed in a plurality of stages, it is easy to control the drawing condition for every stage such as the initial stage, intermediate stage, or later stage of the drawing step.

The plurality of stages of the drawing may be performed in the same drawing bath or using a plurality of separate drawing baths. It is preferable to use a plurality of separate drawing baths because the temperature of the drawing bath and the composition of the drawing bath can be changed for every drawing bath.

The temperature of the drawing bath may be 30° C. to 110° C. from the viewpoint that yarn breakage is suppressed and the artificial hair is likely to have a radiant gloss. When a plurality of drawing baths are used, the temperature of the first drawing bath may be 50° C. to 110° C., or 75° C. to 95° C., from the viewpoint of retaining a high gloss.

When the drawing in the drawing bath is performed using a plurality of drawing baths, the temperature of the drawing bath located on the most upstream side in the fiber transfer direction may be 75° C. to 95° C. because polyacrylonitrile-based artificial hair with a radiant gloss is likely to be obtained.

The filaments (polyacrylonitrile-based artificial hair) obtained through the drawing are typically washed with water in the water-washing step. In the water-washing step, the polyacrylonitrile-based artificial hair drawn in the drawing bath is washed with water to remove an organic solvent from the polyacrylonitrile-based artificial hair. In the water-washing step, it is preferable to use water or an aqueous solution of an organic solvent containing the organic solvent at a lower concentration than in the coagulation bath as a washing liquid, and it is more preferable to use water. The temperature of the washing liquid may be 20° C. to 95° C. The water washing can be performed by immersing the drawn polyacrylonitrile-based artificial hair in a bath containing the washing liquid.

In the water-washing step, the ratio of the total fineness to the width of the polyacrylonitrile-based artificial hair is not particularly limited, and may be 300,000 dtex/cm or less from the viewpoint of enhancing the organic solvent-removing effect.

The polyacrylonitrile-based artificial hair washed with water may be dehydrated in a dehydration step. In the dehydration step, the polyacrylonitrile-based artificial hair washed with water may be dehydrated through pressing with a nip roll.

The nip roll is not particularly limited as long as it is a nip roll that is typically used to produce filaments using a wet spinning method. The wording “pressing with a nip roll” refers to applying pressure to the polyacrylonitrile-based artificial hair while passing the polyacrylonitrile-based artificial hair through between a pair of upper and lower nip rolls. The pressure-application method is not particularly limited as long as pressure can be applied to the polyacrylonitrile-based artificial hair using a nip roll, and examples thereof include applying pressure to the upper nip roll using a cylinder, placing a weight on the upper nip roll, pulling the upper nip roll downward, and the like.

For example, a rubber-based nip roll, a metallic nip roll, and the like can be used as the nip roll. The rubber-based nip roll (also referred to as a “rubber roll”) is favorably used for the upper nip roll, and the metallic nip roll (also referred to as a “metal roll”) is favorably used as the lower nip roll. Examples of the material of the rubber-based nip roll include natural rubber, styrene-butadiene rubber, nitrile rubber, chloroprene rubber, silicone rubber, and the like. The rubber-based nip roll may also be a roll formed by winding rubber around a metallic roll. The thickness of the rubber may be 3 mm or more from the viewpoint of maintaining the cross-sectional shape of the artificial hair. Examples of the material of the metallic nip roll include stainless steel and the like. The hardness of the nip roll may be 40 to 100. The hardness of the nip roll refers to a value obtained by measuring the hardness in conformity with JIS K 6253 using a type-A durometer.

The water washing and the pressing with a nip roll described above may be alternately performed a plurality of times. Alternatively, the pressing with a nip roll may be performed one or more times after the water washing described above is performed two or more times.

The polyacrylonitrile-based artificial hair obtained after the drawing, the polyacrylonitrile-based artificial hair washed with water, or the dehydrated polyacrylonitrile-based artificial hair is subsequently dried in a drying step. In the drying step, it is preferable that substantially all moisture contained in the polyacrylonitrile-based artificial hair is removed. The drying method is not particularly limited as long as moisture in the polyacrylonitrile-based artificial hair can be removed. Examples of the drying method include hot-air drying, drying through contact with a heating roll, and the like. The drying temperature is not particularly limited, and may be, for example, 110° C. to 190° C.

An oil may be attached to the polyacrylonitrile-based artificial hair before the polyacrylonitrile-based artificial hair is dried. The oil may be an oil that is used typically for the purpose of preventing static electricity, preventing agglutination of the polyacrylonitrile-based artificial hair, and improving the texture during the production of the polyacrylonitrile-based artificial hair. A known oil can be used as the oil, and examples thereof include anionic surfactants such as phosphoric acid ester salts and sulfuric acid ester salts; cationic surfactants such as quaternary ammonium salts and imidazolium salts; nonionic surfactants such as ethylene oxide adducts and/or propylene oxide adducts of oils or fats, and polyhydric alcohol partial esters; fats and oils from animals and plants, mineral oils, fatty acid esters; silicone-based surfactants such as amino-modified silicone; and the like. One of these oils may be used alone, or two or more of them may be used in combination.

The dried polyacrylonitrile-based artificial hair may be subjected to further drawing (also referred to as “secondary drawing”) if necessary. The drawing method is not particularly limited, and may be dry drawing or wet drawing. The drawing temperature of the secondary drawing is not particularly limited, and may be, for example, 110° C. to 190° C. or lower. The drawing ratio is not particularly limited, and may be, for example, more than onefold and fourfold or less. The total drawing ratio including the drawing before the drying may be more than onefold and tenfold or less.

It is preferable that the dried polyacrylonitrile-based artificial hair or the polyacrylonitrile-based artificial hair subjected to the secondary drawing is further relaxed in a thermal relaxation step. The relaxation rate is not particularly limited, and may be, for example, 5% to 30%. The thermal relaxation treatment can be performed in a dry heat atmosphere or a superheated steam atmosphere at a high temperature such as 130° C. to 200° C. Alternatively, the thermal relaxation treatment can be performed in a pressurized steam atmosphere or a heated-pressurized steam atmosphere at a pressure of 0.05 MPa. to 0.4 MPa.

### Hair Ornament Product

The polyacrylonitrile-based artificial hair according to one or more embodiments of the present invention alone may be used as artificial hair, or a combination of the polyacrylonitrile-based artificial hair and other fibers for artificial hair may be used as artificial hair. A hair ornament product can be produced using the polyacrylonitrile-based artificial hair according to one or more embodiments of the present invention. This makes it possible to provide the hair ornament product that has a radiant gloss and a low void ratio and can be favorably hackled. The hair ornament product may contain other fibers for artificial hair in addition to the polyacrylonitrile-based artificial hair according to one or more embodiments of the present invention. The other fibers for artificial hair are not particularly limited, and examples thereof include polyvinyl chloride fibers, nylon fibers, polyester fibers, regenerated collagen fibers, and the like.

Examples of the hair ornament product include weaving hair, a wig, a braid, a toupee, a hair extension, a hair accessory, and the like.

### EXAMPLES

Hereinafter, one or more embodiments of the present invention will be described by way of examples, but the present invention is not limited to the following examples.

The measurement methods and the evaluation methods used for examples and comparative examples will be described.

### Adhesion Amount of Oil

About 2 g (sample mass: W0) of a sample (polyacrylonitrile-based artificial hair) was cut into 12 to 15 cm and packed in a stainless-steel tube (oil extraction tube) having a hole of about 1 mm at the lower end. Next, 35 mL of a mixed solution containing ethanol and cyclohexane at a mass ratio of 1:1 was prepared as an extractant for the oil, and about 20 mL of the extractant was poured into the oil extraction tube. The lid of the oil extraction tube was adjusted so that the drop rate of the extractant was about 1 drop per 1 to 1.5 seconds. Then, the extraction of the oil was started. In this case, a tray (empty tray mass: W1) heated to 120° C. using a heater was used as a saucer for receiving liquid drops and placed in such a way that the dropping liquid fell there. When the dropping was finished, the lid was once removed, and the sample present in the oil extraction tube was pushed with a stainless steel rod to squeeze the extractant. This operation was repeated by using the remaining extractant (about 15 mL). Upon the completion of the extraction, the tray was placed in an oven at 90° C. and taken out of the oven after 5 minutes. The total weight (W2) of the tray and the oil on the tray on which the extractant dried out and only the oil remained was measured, and the amount of the oil adhered to 100 parts by mass of the polyacrylonitrile-based artificial hair was calculated using Equation 1 below.

$$Oil adhesion amount ( parts by mass ) = 100 \times ( W 2 - W 1 ) / ( W 0 + W 1 - W 2 ) \qquad Equation 1$$

### Method for Observing Transverse Cross Section of Polyacrylonitrile-Based Artificial Hair

### Preparation of Sample

An appropriate amount of the polyacrylonitrile-based artificial hair that had been cut into 15 cm was packed in a heat-shrinkable tube (manufactured by Junkosha Inc., model number “FEP-040”, inner diameter before shrinkage: 04.5 mm, inner diameter after shrinkage: ø3.3 mm, length: 1 m). The tube was allowed to stand in an oven at 105° C. for 5 minutes. Then, the tube was taken out of the oven and left cooling. After the heat-shrinkable tube was cooled, the tube that had shrunk and been filled with the polyacrylonitrile-based artificial hair was cut to a length of about 3 mm with a razor blade. Thus, samples for observation of the transverse cross section were prepared.

### Observation and Photography

The samples for observation of the transverse cross section were observed at 400-fold magnification using a laser microscope (VK-X260, manufactured by KEYENCE CORPORATION), and images for analysis were photographed (observation and measurement range: 675 μm in width×506 μm in length).

### Method for Analyzing Image of Transverse Cross Section

Image analysis software (WinROOF, Mitsubishi Shosha Co., Ltd.) was used to import the images for analysis, and the following parameters were defined and measured.

### Longest Diameter and Shortest Diameter

In the image for analysis obtained from each sample, the longest diameters of ten randomly selected transverse cross sections were measured, and the average value calculated using these measured values was defined as the longest diameter Lf of the sample.

In the image for analysis obtained from each sample, the shortest diameters of ten randomly selected transverse cross sections were measured, and the average value calculated using these measured values was defined as the shortest diameter Sf of the sample.

### Smallest Cross-Sectional Thickness of Recessed Portion and Largest Cross-Sectional Thickness of Protrusion

In the image for analysis obtained from each sample, the smallest cross-sectional thicknesses of the recessed portions in ten randomly selected transverse cross sections were measured, and the average value calculated using these measured values was defined as the smallest cross-sectional thickness a of the recessed portion of the sample.

In the image for analysis obtained from each sample, the largest cross-sectional thicknesses of the protrusions in ten randomly selected transverse cross sections were measured, and the average value calculated using these measured values was defined as the largest cross-sectional thickness b of the protrusion of the sample.

### Void Ratio

In the image for analysis obtained from each sample, the total number of the transverse cross sections and the number of transverse cross sections inside which a void (pore) was present were visually counted, and the void ratio was calculated using Equation 2 below.

$$Void ratio ( \% ) = 100 \times ( number of transverse cross sections inside which a void is present / total number of transverse cross sections ) \qquad Equation 2$$

### Gloss

The polyacrylonitrile-based artificial hair of 30 cm×30 g (length× weight) was used as a sample, and the sample was placed on a hemicylindrical base with a diameter of 10 cm and was subjected to sensory evaluation by professional beauty evaluators. At this time, the sample was observed in the vertical direction and the left right direction, and the gloss of the sample was graded on a scale of 1 to 5, where 3 was for the gloss of Comparative Standard 1 (polyacrylonitrile-based fibers, “Afrelle” manufactured by Kaneka Corporation), in increments of 0.25. When the gloss evaluation was graded as 4 or more, it was determined that the artificial hair had a radiant gloss.
1: Gloss weaker than gloss of Comparative Standard 1
2: Gloss slightly weaker than gloss of Comparative Standard 1
3: Gloss equivalent to gloss of Comparative Standard 1
4: Radiant gloss slightly stronger than gloss of Comparative Standard 1
5: Radiant gloss stronger than gloss of Comparative Standard 1

### Hue

The polyacrylonitrile-based artificial hair of 30 cm×30 g (length× weight) was used as a sample, and the sample was placed on a hemicylindrical base with a diameter of 10 cm and was subjected to sensory evaluation by professional beauty evaluators. At this time, the sample was observed in the vertical direction and the left right direction, and the hue of the sample was graded on a scale of 1 to 5, where 3 was for the hue of Comparative Standard 1 (polyacrylonitrile-based fibers, black, “Afrelle” manufactured by Kaneka Corporation), in increments of 0.25. The higher the point of the hue evaluation is, the deeper the hue is.
1: Hue paler than hue of Comparative Standard 1
2: Hue slightly paler than hue of Comparative Standard 1
3: Hue equivalent to hue of Comparative Standard 1
4: Hue slightly deeper than hue of Comparative Standard 1
5: Hue deeper than hue of Comparative Standard 1

### Reflectance

The polyacrylonitrile-based artificial hair of 30 cm×25 g (length×weight) was used as a sample, and the sample was set in a groove of a hair bundle measurement jig (manufactured by Konica Minolta, Inc.). After a holder for fixing a hair bundle was moved down, the reflectance was measured four times with the sample being rotated 90° in each measurement at intervals of 10 nm in a wavelength range of 440 to 660 nm using a spectrocolorimeter (CM-2600d″ manufactured by Konica Minolta, Inc.), and the average of the four measurement values was defined as the reflectance at the wavelength. The light source was D65, the viewing angle of the observation view was 2°, and the mask diameter was 8 mm. As the processing for specular reflection, SCI and SCE were simultaneously measured. The UV setting was UV100%.

### Process Stability

The maximum drawing ratio was determined that enables stable drawing without single yarn breakage, drawing breakage, and winding around a drawing roll in the drawing step, and the process stability was evaluated based on the following criteria.
High: The maximum drawing ratio at 130° C. was 3.2-fold or more
Middle: The maximum drawing ratio at 130° C. was 2.9-fold or more and less than 3.2-fold
Low: The maximum drawing ratio at 130° C. was less than 2.9-fold

### Example 1

An acrylonitrile copolymer (with a specific viscosity of 0.174) containing acrylonitrile in an amount of 46 mass %, vinyl chloride in an amount of 52 mass %, and sodium styrenesulfonate in an amount of 2 mass % was dissolved in dimethyl sulfoxide (DMSO) to produce an acrylonitrile copolymer solution having an acrylonitrile copolymer concentration of 26.0 mass % and a water concentration of 2.7 mass %. Next, a spinning solution was produced by adding, to the obtained acrylonitrile copolymer solution, a yellow dye (color index basic yellow 28) in an amount of 0.26 parts by mass with respect to 100 parts by mass of the acrylonitrile copolymer, a red dye (color index basic red 46) in an amount of 0.37 parts by mass with respect to 100 parts by mass of the acrylonitrile copolymer, a blue dye (color index basic blue 41) in an amount of 0.46 parts by mass with respect to 100 parts by mass of the acrylonitrile copolymer, and polyglycidyl methacrylate (with a weight average molecular weight of 12000) in an amount of 0.8 parts by mass with respect to 100 parts by mass of the acrylonitrile copolymer. A spinning nozzle having a substantially broad bean-shaped transverse cross section shown in FIG. 4 and a size shown in Table 1 was used to extrude the spinning solution into a coagulation bath containing a 47 mass % aqueous solution of DMSO at 35° C. so that wet spinning was performed at a spinning rate of 5 m/min. Then, the coagulated filaments were drawn to 2.1 times their original length in a drawing bath containing a 50 mass % aqueous solution of DMSO at 75° C. Subsequently, the filaments were washed with warm water at 90° C., and were immersed in an oil tank (60° C.) containing an oil (a mixed oil composed of POE castor oil, sorbitan stearate, and an amide-based oil) for 1 to 3 seconds to impregnate the filaments with the oil. Thereafter, the filaments were dried at 140° C. and were then drawn to 3 times their original length. The resulting yarns were subjected to a 27% relaxation treatment at 155° C. Thus, polyacrylonitrile-based artificial hair (the adhesion amount of the oil: 0.2 parts by mass) having a single fiber fineness of about 46 dtex was produced.

### Examples 2 to 6

Polyacrylonitrile-based artificial hair (the adhesion amount of the oil: 0.2 parts by mass) having a single fiber fineness of about 46 dtex was produced in the same manner as in Example 1, except that a spinning nozzle having a shape shown in FIG. 4 and a size shown in Table 1 was used.

### Comparative Example 1

Polyacrylonitrile-based artificial hair (the adhesion amount of the oil: 0.2 parts by mass) having a single fiber fineness of about 46 dtex was produced in the same manner as in Example 1, except that a spinning nozzle having a shape shown in FIG. 4 and a size shown in Table 1 was used.

### Comparative Example 2

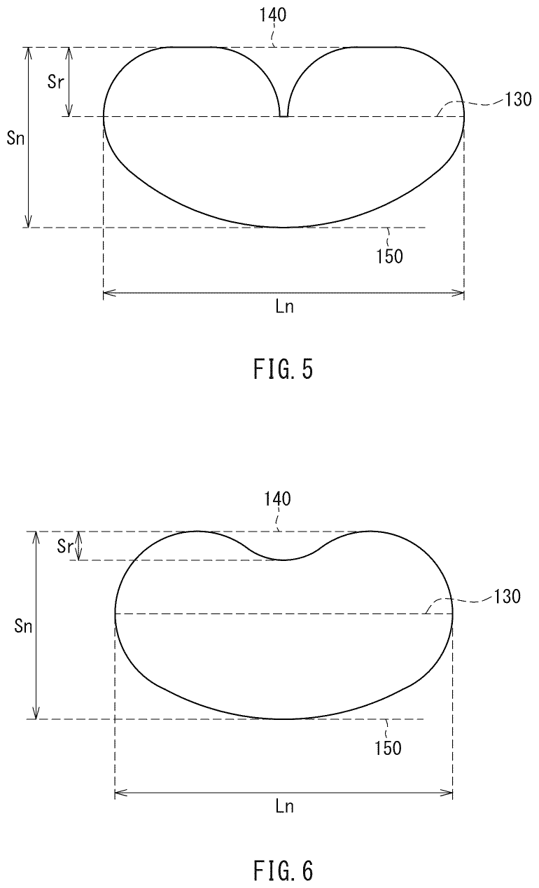

Polyacrylonitrile-based artificial hair (the adhesion amount of the oil: 0.2 parts by mass) having a single fiber fineness of about 46 dtex was produced in the same manner as in Example 1, except that a spinning nozzle having a shape shown in FIG. 5 and a size shown in Table 1 was used. In the nozzle having a substantially broad bean-shaped transverse cross section shown in FIG. 5, the bottom of the recessed portion is located on the major axis, and therefore, the recessed portion does not have a width Lr on the major axis.

### Comparative Example 3

Polyacrylonitrile-based artificial hair (the adhesion amount of the oil: 0.2 parts by mass) having a single fiber fineness of about 46 dtex was produced in the same manner as in Example 1, except that a spinning nozzle having a shape shown in FIG. 6 and a size shown in Table 1 was used. In the nozzle having a substantially broad bean-shaped transverse cross section shown in FIG. 6, the major axis is located below the bottom of the recessed portion, and therefore, the recessed portion does not have a width Lr on the major axis.

### Comparative Example 4

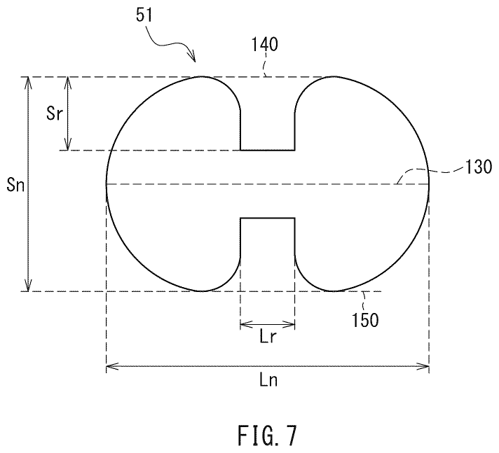

Polyacrylonitrile-based artificial hair (the adhesion amount of the oil: 0.2 parts by mass) having a single fiber fineness of about 46 dtex was produced in the same manner as in Example 1, except that a spinning nozzle having a shape shown in FIG. 7 and a size shown in Table 1 was used. In the nozzle having a dumbbell-shaped transverse cross section shown in FIG. 7, Lr means the width of the bottom of the recessed portion.

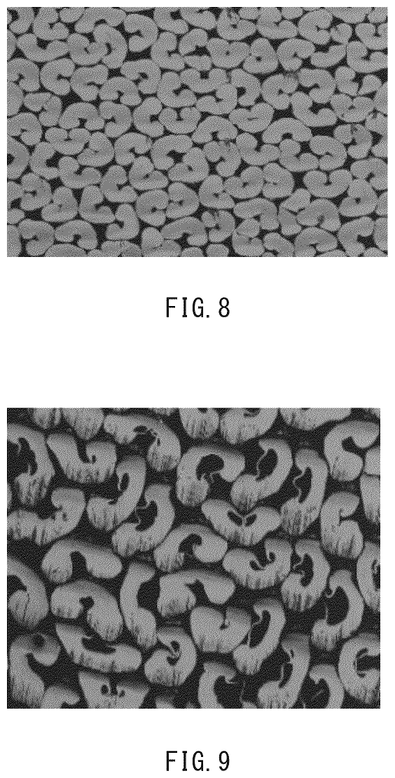

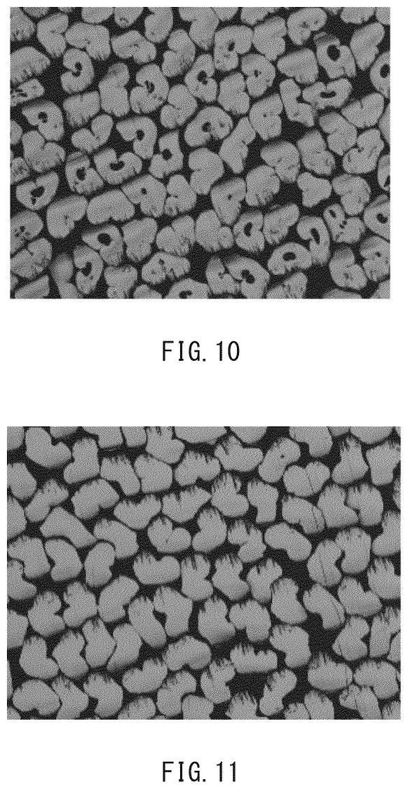

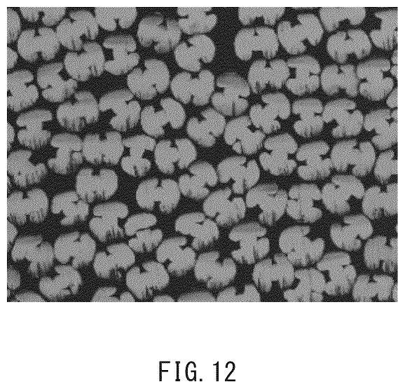

The transverse cross sections of the polyacrylonitrile-based artificial hair of the examples and the comparative examples were observed and evaluated as described above, and the results are shown in Table 1 below. The characteristics of the polyacrylonitrile-based artificial hair of the examples and the comparative examples were determined as described above, and the results are shown in Table 1 below. Photographs showing the transverse cross sections of polyacrylonitrile-based artificial hair of Example 1 and Comparative Examples 1 to 4 are shown in FIGS. 8 to 12, respectively. The reflectance of the polyacrylonitrile-based artificial hair of Examples 1 and 2 and Comparative Example 1 was measured as described above, and the results are shown in Table 2 below.

TABLE 1

| | | | | | | | | Comp. | Comp. | Comp | Comp. |
|---|---|---|---|---|---|---|---|---|---|---|---|
| | | Ex. 1 | Ex. 2 | Ex. 3 | Ex. 4 | Ex. 5 | Ex. 6 | Ex. 1 | Ex. 2 | Ex. 3 | Ex. 4 |
| Nozzle | Shape | Substantially broad bean shape | | | | | | Substantially broad bean shape | | | Dumbbell shape |
| | Longest diameter | 0.5 | 0.5 | 0.47 | 0.48 | 0.47 | 0.47 | 0.5 | 0.47 | 0.44 | 0.42 |
| | Ln (mm) | | | | | | | | | | |
| | Shortest diameter | 0.24 | 0.24 | 0.246 | 0.246 | 0.246 | 0.246 | 0.24 | 0.2345 | 0.243 | 0.279 |
| | Sn (mm) | | | | | | | | | | |
| | Aspect ratio | 2.08 | 2.08 | 1.91 | 1.95 | 1.91 | 1.91 | 2.08 | 2.00 | 1.81 | 1.51 |
| | (Ln/Sn) | | | | | | | | | | |
| | Depth Sr (mm) of | 0.115 | 0.13 | 0.12 | 0.12 | 0.12 | 0.12 | 0.16 | 0.09 | 0.037 | 0.0955 |
| | recessed portion | | | | | | | | | | |
| | Depth ratio | 0.479 | 0.542 | 0.488 | 0.488 | 0.488 | 0.488 | 0.667 | 0.384 | 0.152 | 0.342 |
| | (Sr/Sn) of | | | | | | | | | | |
| | recessed portion | | | | | | | | | | |
| | Width Lr (mm) | 0.075 | 0.06 | 0.06 | 0.07 | 0.065 | 0.07 | 0.06 | — | — | 0.07 |
| | of recessed | | | | | | | | | | |
| | portion | | | | | | | | | | |
| | Width ratio | 0.150 | 0.120 | 0.128 | 0.146 | 0.138 | 0.149 | 0.120 | — | — | 0.167 |
| | (Lr/Ln) of | | | | | | | | | | |
| | recessed portion | | | | | | | | | | |
| Maximum drawing ratio at | | 3.48 | 3.28 | 3.24 | 3.36 | 3.26 | 3.40 | 3.21 | 3.31 | 2.62 | 3.04 |
| 130° C. (times) | | | | | | | | | | | |
| Process stability | | High | High | High | High | High | High | High | High | Low | Medium |
| Artificial | Shape | Substantially broad bean shape | | | | | | Substantially broad bean shape | | | Dumbbell shape |
| hair cross | Longest diameter | 85.96 | 89.96 | 84.37 | 82.11 | 83.13 | 84.11 | 136.82 | 90.96 | 87.69 | 78.38 |
| section | Lf (μm) | | | | | | | | | | |
| | Shortest diameter | 58.8 | 59.2 | 64.28 | 61.43 | 60.49 | 63.54 | 85.75 | 60.29 | 59.60 | 67.21 |
| | Sf (μm) | | | | | | | | | | |
| | Aspect ratio | 1.462 | 1.520 | 1.313 | 1.337 | 1.374 | 1.324 | 1.596 | 1.51 | 1.47 | 1.17 |
| | (Lf/Sf) | | | | | | | | | | |
| | Cross-sectional | 29.50 | 26.06 | 31.48 | 30.82 | 30.14 | 30.31 | 29.98 | 36.02 | 45.15 | 28.26 |
| | thickness a (μm) | | | | | | | | | | |
| | of recessed | | | | | | | | | | |
| | portion | | | | | | | | | | |
| | Largest cross- | 39.59 | 40.98 | 40.19 | 38.66 | 38.95 | 37.88 | 61.23 | 38.92 | 25.24 | 25.66 |
| | sectional | | | | | | | | | | |
| | thickness b (μm) | | | | | | | | | | |
| | of protrusion | | | | | | | | | | |
| | Cross-sectional | 0.745 | 0.636 | 0.783 | 0.797 | 0.774 | 0.800 | 0.490 | 0.925 | 1.789 | 1.101 |
| | thickness ratio | | | | | | | | | | |
| | (a/b) | | | | | | | | | | |
| | b/Lf | 0.461 | 0.456 | 0.476 | 0.471 | 0.469 | 0.450 | 0.448 | 0.428 | 0.288 | 0.327 |
| | a/Sf | 0.502 | 0.440 | 0.490 | 0.502 | 0.498 | 0.477 | 0.350 | 0.597 | 0.758 | 0.420 |
| Artificial | Gloss | 5 | 5 | 4 | 4 | 4 | 4 | Not measured | 5 | 5 | 2.5 |
| hair | Void Ratio (%) | 3 | 23 | 5.2 | 0.78 | 0.76 | 0 | 90 | 51 | 0 | 7.4 |
| | Hue | 5 | 4.75 | 4.5 | 4.5 | 4.5 | 4.5 | Not measured | 4.5 | 4.75 | 4.5 |

TABLE 2

| | |
|---|---|
| Wavelength | Reflectance (%) |

| (nm) | Ex. 1 | Ex. 2 | Comp. Ex. 4 |
|---|---|---|---|
| 440 | 1.4950 | 1.6300 | 1.7425 |
| 450 | 1.5125 | 1.6625 | 1.7725 |
| 460 | 1.4600 | 1.6000 | 1.7175 |
| 470 | 1.5125 | 1.6550 | 1.7550 |
| 480 | 1.4875 | 1.6300 | 1.7450 |
| 490 | 1.5075 | 1.6250 | 1.7600 |
| 500 | 1.5525 | 1.6850 | 1.7950 |
| 510 | 1.5375 | 1.6600 | 1.8050 |
| 520 | 1.5375 | 1.6500 | 1.8025 |
| 530 | 1.5550 | 1.6850 | 1.8075 |
| 540 | 1.5725 | 1.7100 | 1.8225 |
| 550 | 1.5750 | 1.7000 | 1.8125 |
| 560 | 1.5700 | 1.7125 | 1.8300 |
| 570 | 1.5800 | 1.7225 | 1.8400 |
| 580 | 1.5525 | 1.6800 | 1.8175 |
| 590 | 1.5825 | 1.7100 | 1.8250 |
| 600 | 1.5875 | 1.7250 | 1.8350 |
| 610 | 1.5325 | 1.6575 | 1.7700 |
| 620 | 1.5000 | 1.6200 | 1.7400 |
| 630 | 1.6125 | 1.7350 | 1.8425 |
| 640 | 1.5625 | 1.6925 | 1.8150 |
| 650 | 1.6225 | 1.7300 | 1.8575 |
| 660 | 1.6500 | 1.8225 | 1.8725 |
| 440 to 660 (average | 1.5254 | 1.6577 | 1.7781 |
| reflectance) | | | |

As can be seen from Table 1, the polyacrylonitrile-based artificial hair of the examples has high process stability, radiant gloss, and a low void ratio.

Meanwhile, the polyacrylonitrile-based artificial hair of Comparative Examples 1 and 2 having a substantially broad bean-shaped transverse cross section but a thickness ratio a/b of the transverse cross section outside a range of 0.51 to 0.91 had a high void ratio. Also, the polyacrylonitrile-based artificial hair of Comparative Example 3 having a substantially broad bean-shaped transverse cross section but the major axis of the transverse cross section located below the bottom of the recessed portion of the transverse cross section had low process stability. The polyacrylonitrile-based artificial hair of Comparative Example 4 having a dumbbell-shaped transverse cross section could not have a radiant gloss.

In addition, the polyacrylonitrile-based artificial hair of the examples having a substantially broad bean-shaped transverse cross section had favorable touch compared with the polyacrylonitrile-based artificial hair of Comparative Example 4 having a dumbbell-shaped transverse cross section.

As can be seen from Table 2, the polyacrylonitrile-based artificial hair of the examples had a low average reflectance (a range of 1.20% to 1.75%) within the wavelength range (visible ray of light) of 440 to 660 nm, and had excellent radiant gloss, compared with the polyacrylonitrile-based artificial hair of the comparative examples.

One or more embodiments of the present invention are not particularly limited, but encompasses at least the following embodiments.

[1] A polyacrylonitrile-based artificial hair having a broad bean-shaped transverse cross section having an outer peripheral shape that includes an upper peripheral portion with a recessed portion having a curved shape at the center, and a lower peripheral portion curved in an arc,
wherein in the transverse cross section, a ratio Lf/Sf of a longest diameter Lf to a shortest diameter Sf is 1.20 or more,
in the transverse cross section, a ratio a/b of a smallest cross-sectional thickness a of the recessed portion to a largest cross-sectional thickness b of protrusions on both sides of the recessed portion is 0.51 to 0.91,
a major axis of the transverse cross section is located above a bottom of the recessed portion,
the major axis is a longest line segment among line segments connecting any two points on an outer periphery of the transverse cross section,
the longest diameter Lf indicates a length of the major axis and the shortest diameter Sf indicates a direct distance between two parallel lines that are parallel to the major axis and between which the transverse cross section is sandwiched, and
the smallest cross-sectional thickness a of the recessed portion indicates the smallest thickness of a portion right below the bottom of the recessed portion in the transverse cross section and the largest cross-sectional thickness b of the protrusions indicates the largest thickness of portions above the bottom of the recessed portion in the protrusions in the transverse cross section.

[2] The polyacrylonitrile-based artificial hair according to [1], wherein the polyacrylonitrile-based artificial hair has a void ratio of 30% or less.

[3] The polyacrylonitrile-based artificial hair according to [1] or [2], wherein the polyacrylonitrile-based artificial hair has a single fiber fineness of 30 to 60 dtex.

[4] The polyacrylonitrile-based artificial hair according to any one of [1] to [3], wherein the polyacrylonitrile-based artificial hair contains an acrylonitrile copolymer, and the acrylonitrile copolymer contains a constitutional unit derived from acrylonitrile in an amount of 29.5 mass % to 79.5 mass %, a constitutional unit derived from one or more halogen-containing monomers selected from the group consisting of vinyl chloride and vinylidene chloride in an amount of 20 mass % to 70 mass %, and a constitutional unit derived from a sulfonic acid group-containing vinyl monomer in an amount of 0.5 mass % to 5 mass %.

[5] The polyacrylonitrile-based artificial hair according to any one of [1] to [4], wherein the polyacrylonitrile-based artificial hair has an average reflectance within a wavelength range of 440 to 660 nm of 1.75% or less.

[6] A hair ornament product including the polyacrylonitrile-based artificial hair according to any one of [1] to [5].

[7] The hair ornament product according to [6], wherein the hair ornament product includes at least one selected from the group consisting of weaving hair, a wig, a braid, a toupee, a hair extension, and a hair accessory.

[8] A method for producing polyacrylonitrile-based artificial hair, including performing wet spinning using a spinning solution containing an acrylonitrile copolymer,
wherein a nozzle used for the wet spinning has a broad bean-shaped transverse cross section having an outer peripheral shape that includes an upper peripheral portion with a recessed portion having a curved shape at the center, and a lower peripheral portion curved in an arc,
a ratio Ln/Sn of a longest diameter Ln of the transverse cross section of the nozzle to a shortest diameter Sn of the transverse cross section is 1.60 or more,
in the transverse cross section of the nozzle, a ratio Sr/Sn of a depth Sr of the recessed portion to the shortest diameter Sn is 0.40 to 0.65,
a major axis of the transverse cross section of the nozzle is located above a bottom of the recessed portion,
the major axis is a longest line segment among line segments connecting any two points on an outer periphery of the transverse cross section of the nozzle,
the longest diameter Ln indicates a length of the major axis and the shortest diameter Sn indicates a direct distance between two parallel lines that are parallel to the major axis and between which the transverse cross section of the nozzle is sandwiched, and
the depth Sr of the recessed portion indicates a direct distance from a parallel line that is one of the two parallel lines and is located above the bottom of the recessed portion, to the bottom of the recessed portion.

[9] The method for producing polyacrylonitrile-based artificial hair according to [8],
wherein in the transverse cross section of the nozzle, a ratio Lr/Ln of a width Lr of the recessed portion to the longest diameter Ln is 0.125 or more, and
the width Lr of the recessed portion indicates a width on the major axis of the recessed portion.

[10] The method for producing polyacrylonitrile-based artificial hair according to [8] or [9], wherein the acrylonitrile copolymer contains a constitutional unit derived from acrylonitrile in an amount of 29.5 mass % to 79.5 mass %, a constitutional unit derived from one or more halogen-containing monomers selected from the group consisting of vinyl chloride and vinylidene chloride in an amount of 20 mass % to 70 mass %, and a constitutional unit derived from a sulfonic acid group-containing vinyl monomer in an amount of 0.5 mass % to 5 mass %.

### DESCRIPTION OF REFERENCE NUMERALS

1, 11, 21 Polyacrylonitrile-based artificial hair (transverse cross section)
2, 12, 22 Recessed portion
3, 13, 23 Upper peripheral portion
4, 14, 24 Lower peripheral portion
5, 6, 15, 16, 25, 26 Protrusion
30 Major axis
40, 50 Parallel line
101 Spinning nozzle (transverse cross section)
102 Recessed portion
103 Upper peripheral portion
104 Lower peripheral portion
105, 106 Protrusion
130 Major axis
140, 150 Parallel line

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A polyacrylonitrile-based artificial hair comprising:
a broad bean-shaped transverse cross section having an outer peripheral shape that includes:
an upper peripheral portion with a recessed portion having a curved shape at a center of the upper peripheral portion, and
a lower peripheral portion curved in an arc,
wherein in the broad bean-shaped transverse cross section, a ratio Lf/Sf of a longest diameter Lf to a shortest diameter Sf is 1.20 or more,
in the broad bean-shaped transverse cross section, a ratio a/b of a smallest cross-sectional thickness a of the recessed portion to a largest cross-sectional thickness b of protrusions on both sides of the recessed portion is 0.51 to 0.91, a major axis of the broad bean-shaped transverse cross section is located above a bottom of the recessed portion,
the major axis is a longest line segment among line segments connecting any two points on an outer periphery of the transverse cross section,
the longest diameter Lf indicates a length of the major axis,
the shortest diameter Sf indicates a direct distance between two parallel lines that are parallel to the major axis, wherein the two parallel lines sandwich the broad bean-shaped transverse cross section,
the smallest cross-sectional thickness a of the recessed portion indicates a smallest thickness of a portion directly below the bottom of the recessed portion in the broad bean-shaped transverse cross section, and
the largest cross-sectional thickness b of the protrusions indicates a largest thickness of portions above the bottom of the recessed portion and in the protrusions of the broad bean-shaped transverse cross section.

2. The polyacrylonitrile-based artificial hair according to claim 1, wherein the polyacrylonitrile-based artificial hair has a void ratio of 30% or less.

3. The polyacrylonitrile-based artificial hair according to claim 1, wherein the polyacrylonitrile-based artificial hair has a single fiber fineness of 30 to 60 dtex.

4. The polyacrylonitrile-based artificial hair according to claim 1, wherein the polyacrylonitrile-based artificial hair contains an acrylonitrile copolymer, comprising:
a constitutional unit derived from acrylonitrile in an amount of 29.5 mass % to 79.5 mass %;
a constitutional unit derived from one or more halogen-containing monomers selected from the group consisting of vinyl chloride and vinylidene chloride in an amount of 20 mass % to 70 mass %; and
a constitutional unit derived from a sulfonic acid group-containing vinyl monomer in an amount of 0.5 mass % to 5 mass %.

5. The polyacrylonitrile-based artificial hair according to claim 1, wherein the polyacrylonitrile-based artificial hair has an average reflectance within a wavelength range of 440 to 660 nm of 1.75% or less.

6. A hair ornament product comprising the polyacrylonitrile-based artificial hair according to claim 1.

7. The hair ornament product according to claim 6, wherein the hair ornament product is at least one selected from the group consisting of weaving hair, a wig, a braid, a toupee, a hair extension, and a hair accessory.

8. The hair ornament product according to claim 6, wherein the polyacrylonitrile-based artificial hair has a void ratio of 30% or less.

9. The hair ornament product according to claim 6, wherein the polyacrylonitrile-based artificial hair has a single fiber fineness of 30 to 60 dtex.

10. The hair ornament product according to claim 6, wherein the polyacrylonitrile-based artificial hair contains an acrylonitrile copolymer comprising:
a constitutional unit derived from acrylonitrile in an amount of 29.5 mass % to 79.5 mass %,
a constitutional unit derived from one or more halogen-containing monomers selected from the group consisting of vinyl chloride and vinylidene chloride in an amount of 20 mass % to 70 mass %, and
a constitutional unit derived from a sulfonic acid group-containing vinyl monomer in an amount of 0.5 mass % to 5 mass %.

11. The hair ornament product according to claim 6, wherein the polyacrylonitrile-based artificial hair has an average reflectance within a wavelength range of 440 to 660 nm of 1.75% or less.

12. A method for producing polyacrylonitrile-based artificial hair, comprising performing wet spinning using a spinning solution containing an acrylonitrile copolymer,
wherein a nozzle for performing the wet spinning has a broad bean-shaped transverse cross section having an outer peripheral shape that includes:
an upper peripheral portion with a recessed portion having a curved shape at a center of the upper peripheral portion, and
a lower peripheral portion curved in an arc,
a ratio Ln/Sn of a longest diameter Ln of the broad bean-shaped transverse cross section of the nozzle to a shortest diameter Sn of the broad bean-shaped transverse cross section is 1.60 or more,
in the broad bean-shaped transverse cross section of the nozzle, a ratio Sr/Sn of a depth Sr of the recessed portion to the shortest diameter Sn is 0.40 to 0.65,
a major axis of the broad bean-shaped transverse cross section of the nozzle is located above a bottom of the recessed portion,
the major axis is a longest line segment among line segments connecting any two points on an outer periphery of the broad bean-shaped transverse cross section of the nozzle,
the longest diameter Ln indicates a length of the major axis,
the shortest diameter Sn indicates a direct distance between two parallel lines that are parallel to the major axis, wherein the two parallel lines sandwich the broad bean-shaped transverse cross section of the nozzle, and
the depth Sr of the recessed portion indicates a direct distance between a parallel line that is one of the two parallel lines located above the bottom of the recessed portion and the bottom of the recessed portion.

13. The method for producing polyacrylonitrile-based artificial hair according to claim 12,
wherein in the broad bean-shaped transverse cross section of the nozzle, a ratio Lr/Ln of a width Lr of the recessed portion to the longest diameter Ln is 0.125 or more, and
the width Lr of the recessed portion indicates a width on the major axis of the recessed portion.

14. The method for producing polyacrylonitrile-based artificial hair according to claim 12, wherein the acrylonitrile copolymer comprises:
a constitutional unit derived from acrylonitrile in an amount of 29.5 mass % to 79.5 mass %;
a constitutional unit derived from one or more halogen-containing monomers selected from the group consisting of vinyl chloride and vinylidene chloride in an amount of 20 mass % to 70 mass %; and
a constitutional unit derived from a sulfonic acid group-containing vinyl monomer in an amount of 0.5 mass % to 5 mass %.

15. The method for producing polyacrylonitrile-based artificial hair according to claim 13, wherein the acrylonitrile copolymer comprises:
a constitutional unit derived from acrylonitrile in an amount of 29.5 mass % to 79.5 mass %;
a constitutional unit derived from one or more halogen-containing monomers selected from the group consisting of vinyl chloride and vinylidene chloride in an amount of 20 mass % to 70 mass %; and
a constitutional unit derived from a sulfonic acid group-containing vinyl monomer in an amount of 0.5 mass % to 5 mass %.
